(19) United States
(12) Patent Application Publication
(10) Pub. No.: US 2003/0217434 A1
(43) Pub. Date: Nov. 27, 2003

(54) Device for personalizing toothbrushes

(76) Inventor: Marco Ugo De Rosa, Torino (IT)

Correspondence Address: SUGHRUE MION, PLLC, 2100 Pennsylvania Avenue, NW, Washington, DC, 20037-3213, US

(21) Appl. No.: 10/442,949

(22) Filed: May 22, 2003

(30) Foreign Application Priority Data
May 23, 2002 (IT) TO2002U000105

(51) Int. Cl. E05B 1/00

(52) U.S. Cl. 16/110.1

(57) ABSTRACT

A device for personalizing a toothbrush comprises a tubular elastic sheath (10) designed to be applied to the handle of a toothbrush (16) and bears visual means of personalization (18, 20) for enabling the user to distinguish between toothbrushes that are similar. The sheath (10) is able to deform elastically for adhering to the handles of toothbrushes (16) of different shapes and sizes.

### TEXT OF THE DESCRIPTION

The present invention relates to a device for personalizing toothbrushes. In particular, the present invention relates to a personalization device designed to be applied to the handle of a toothbrush and comprising visual elements of personalization for enabling the user to distinguish his own toothbrush from toothbrushes that are similar or identical thereto.

The need for personalizing toothbrushes is well known to manufacturers of toothbrushes, who normally produce the same model of toothbrush with handles of different colours. It has also been proposed (see the document WO-01/64072) to use bristles of different colours arranged so as to create a personalization pattern or symbol.

The level of personalization that can be obtained in this way is, however, rather limited, both on account of the costs of production of the toothbrushes, which increase with the refinement of the degree of personalization and on account of the difficulties involved in the management of the supplies if the aim is to guarantee a high degree of personalization in the points of sale.

The document U.S. Pat. No. 2,489,707 describes a means for the identification of the toothbrush obtained through the creation inside the handle of the toothbrush of a space designed to contain a personalizable label, visible from outside, where said space is sealed in such a way as to prevent penetration of liquids and the consequent deterioration of the label. The problem inherent in this solution is that the toothbrush must be made so as to be able to receive the personalizable label, so that this personalization system is not universally applicable.

The document U.S. Pat. No. 5,860,190 describes a thick-walled tubular handle designed to be applied to cutlery, toothbrushes and various tools with the aim of facilitating gripping of said objects by persons with reduced gripping capacity. This handle is not usable for the purpose of personalizing toothbrushes because it would render use of the toothbrush inconvenient for persons with normal gripping capacity.

The purpose of the present invention is to provide a device for personalizing toothbrushes that is simple, of low cost, and can be used on any type of toothbrush.

According to the present invention, the above purpose is achieved by a personalization device having the characteristics forming the subject of the main claim.

The present invention will now be described in detail with reference to the annexed drawings, which are provided purely by way of non-limiting example and in which:

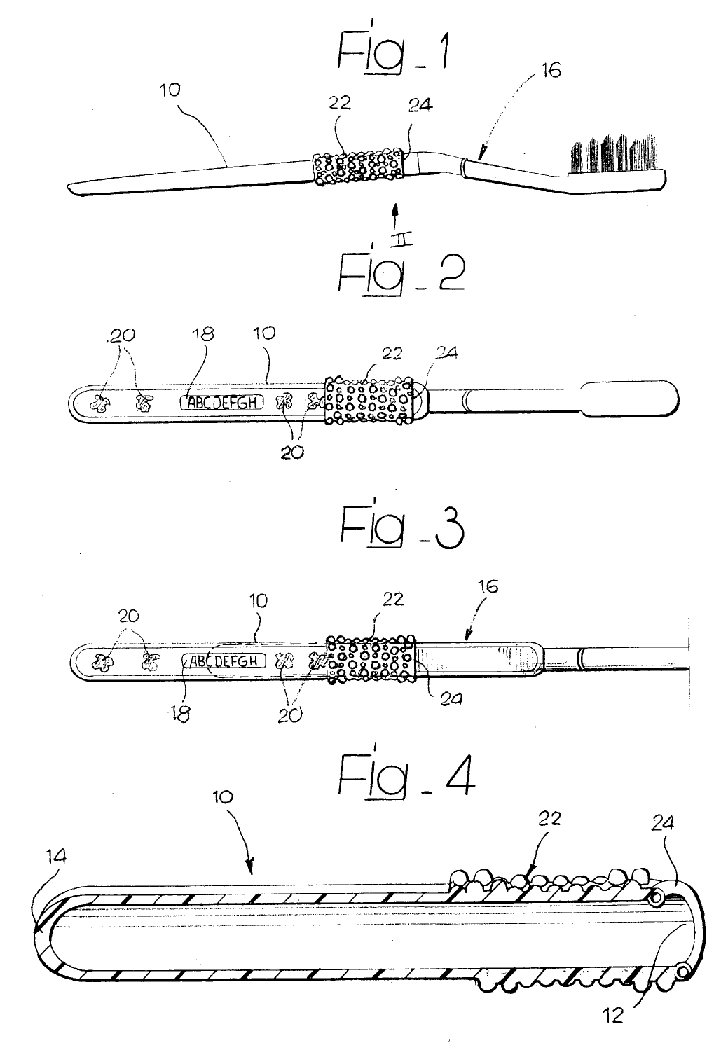

FIG. 1 is a side view of a personalization device according to the present invention applied to a toothbrush;

FIG. 2 is a view according to the arrow II of the toothbrush of FIG. 1;

FIG. 3 illustrates a personalization device according to the present invention during its application on the handle of a toothbrush; and

FIG. 4 is a schematic cross-sectional view of a personalization device according to the present invention.

With reference to the figures, the personalization device according to the present invention is essentially made up of a thin-walled elastic sheath 10 which can be dilated elastically so as to adhere to the outer surface of the handle of a toothbrush of any shape and size. The elastic sheath 10 has a tubular shape with an open end 12 and a closed end 14.

FIG. 3 illustrates the sheath 10 whilst it is being slid onto the handle of a toothbrush 16. FIGS. 1 and 2 illustrate how the sheath 10 adheres elastically to the outer surface of the toothbrush when it is completely fitted on the handle.

The sheath 10 is equipped with visual means of personalization of the user when the sheath is fitted on the handle of the toothbrush 16 in order to enable the user to distinguish visually his own toothbrush from toothbrushes that are the same as or similar to his own. The personalization means can be made up of wordings, patterns, symbols, colours, or any combination thereof. By way of example, FIG. 2 illustrates how the sheath 10 can be provided with an area 18 on which there is printed a writing, for example the user's first name or any other word, which is visible to the user when the sheath is fitted on the handle of the toothbrush. The visual means of personalization of the sheath 10 may also consist of patterns 20 or else the colour or a combination of colours of the sheath 10. The means of personalization comprising wordings, patterns and colours can be used individually or else in combination with one another to increase the combinations of personalization that can be obtained. In addition, the sheath 10 may be at least in part transparent so as to make visible to the user the personalizations already present on the toothbrush 16.

The sheath 10 may also present an internal portion designed for receiving a personalization plate that can be seen from outside (not illustrated).

The sheath 10 may be equipped on its outer surface, in the proximity of its open end 12, with a region 22 having elements in relief, with the aim of facilitating gripping by the user. The edge of the opening 12 may be formed by a ring 24 with a greater thickness than that of the remaining part of the sheath in order to form a closing area that prevents penetration of liquids into the space between the outer surface of the handle of the toothbrush and the internal surface of the sheath 10.

The sheath 10 is preferably made of an elastic material that is resistant and non-allergic, such as for example natural latex, or elastomers or polymers of natural or synthetic origin. The intrinsic elastic properties of the sheath 10 enables its application to and removal from the handle of the toothbrush and the re-use of the sheath 10 with a new toothbrush.

The sheath 10 can have a length of between approximately 8 and 14 cm and a diameter such that the sheath can be fitted on the handle of any commercially available toothbrush by applying a force of compression sufficient for the sheath to adhere to the handle. Obviously, on toothbrushes with handles of larger sizes, there will be exerted a greater adherence. It is important that the sheath should exert an adequate pressure on the entire surface of the handle of the toothbrush, in such a way as to enable optimal adherence, which will be able to prevent the sliding of the sheath on the handle during use of the toothbrush. The thickness of the sheath 10 depends upon the characteristics of the material constituting the sheath itself, but must guarantee a sufficient resistance for the successive use of three or four toothbrushes. Since the sheath 10 is made of an elastic material of a rubbery type, this renders the handle of the toothbrush completely anti-slip.

1. A device for personalizing a toothbrush, designed to be applied to the handle of a toothbrush comprising an elastic sheath bearing visual means of personalization for enabling the user to distinguish between toothbrushes that are similar, said sheath being able to deform elastically for adhering to handles of toothbrushes of different shapes and sizes.

2. The device according to claim 1, wherein said sheath has a tubular shape with at least one open end.

3. The device according to claim 2, wherein said sheath has a closed end.

4. The device according to claim 2, wherein said sheath has a ring of greater thickness at said open end.

5. The device according to claim 2, wherein said sheath comprises a region with elements in relief set at said open end.

6. The device according to claim 1, wherein said visual means of personalization comprise wordings, patterns, symbols, colours, or any combination thereof.

7. The device according to claim 1, wherein said sheath is designed to contain a personalization plate visible from outside.

8. The device according to claim 1, wherein said sheath is at least in part transparent.

9. The device according to claim 1, wherein said sheath is made of a material selected from the group consisting of natural latex, elastomers or polymers of natural or synthetic origin.
